(19) United States
(12) Patent Application Publication
(10) Pub. No.: US 2003/0014275 A1
(43) Pub. Date: Jan. 16, 2003

(54) Attendee electronic sporting event information transmitting and storage systems

(76) Inventors: Fred E. Bearden III, Laguna Niguel, CA (US); John McNicol, Rancho Santa Margarita, CA (US)

Correspondence Address: LYON & LYON LLP, 633 WEST FIFTH STREET, SUITE 4700, LOS ANGELES, CA, 90071, US

(21) Appl. No.: 10/172,226

(22) Filed: Jun. 14, 2002

Related U.S. Application Data
(63) Continuation-in-part of application No. 09/481,778, filed on Jan. 11, 2000.
Application No. 09/481,778 is a continuation-in-part of application No. 09/241,937, filed on Feb. 2, 1999, now Pat. No. 6,347,301.

(51) Int. Cl. G06F 17/60

(52) U.S. Cl. 705/1

(57) ABSTRACT

Systems and methods for distributing real-time data to attendees at a sporting event, and for enabling the attendees to participate in interactive activities while at the sporting event, are provided. A system for distributing real-time sporting event-related data and/or enabling attendees to participate in interactive activities, all while at the local area of the sporting event, includes a central computer, a data distribution node located within the local area, and a plurality of hand-held computers configured to communicate with the data distribution node. The system may be used to enable attendees to retrieve data regarding the sporting event on demand, while at the local area, using a hand-held computer. The system may also be used to enable attendees to participate in interactive activities while at the local area of the sporting event, using a hand-held computer.

### BACKGROUND OF THE INVENTION

This Application is a continuation-in-part of U.S. application Ser. No. 09/481,778, filed on Jan. 11, 2000, now pending, which is a continuation-in-part of U.S. application Ser. No. 09/241,937 filed on Feb. 2, 1999, now issued as U.S. Pat. No. 6,347,301, the disclosures of which are expressly and fully incorporated by reference herein.

### FIELD OF THE INVENTION

This invention relates generally to data distribution networks, and more particularly to a data distribution network that distributes real-time data directly to consumers via data distribution nodes installed in locations accessible to the consumer when the data is required.

### DESCRIPTION OF RELATED ART

The following art defines the present state of this field: Newell, U.S. Pat. No. 4,387,296, discloses a portable computer for use in the utility industry. A user reads the numeric information on the utility meter, enters the data into the computer, and is then able to manipulate the data associated with that account, including calculating the customer's bill. Blum, U.S. Pat. No. 4,628,193, discloses a hand-held electronic apparatus that contains a database of information about a plurality of workers. The user inputs an alphanumeric identifier, such as the worker's identity, and is able to access data about that person, specifically, what assignment that worker should receive.

Many similar references disclose handheld computers being used to access databases of information about persons and inventories in response to either alphanumeric or machine-readable indicia. O'Hagan, U.S. Pat. No. 5,821,512, and Overman, U.S. Pat. No. 5,483,472, disclose shopping cart or hand-held portable computers for retrieving information about products while shopping. Nishiyama, U.S. Pat. No. 5,721,942, discloses a personal information display system for serving large capacities of general information to user-designated stations at user-designated times. Smith, U.S. Pat. No. 5,455,409, discloses an apparatus for monitoring a plurality of coded articles and for identifying the location of selected items. Ray. U.S. Pat. No. 5,380,994, discloses a hand-held computer for inventory control. Koenck, U.S. Pat. No. 5,331,136, discloses a hand-held computer data-capture system. Sussman, U.S. Pat. No. 5,262,940, discloses a portable media tracking device.

It is also known to send data to a cellular phone, as discussed in The Economist, Special Telecommunications Supplement, Oct. 9-15, 1999. This article discusses novel cellular phones that have many computer-like functions, such as maintaining your calendar and contact database. The article also discusses the novel cellular phones that send and receive data, including sports scores, stock data, biorhythms, and even dating services.

The prior art teaches the use of computer networks to disseminate data through an organization to achieve certain goals, such as inventory control. However, the prior art does not teach a centrally located computer that distributes a stream of constantly updated data to a plurality of data distribution nodes for periodic download to a plurality of hand-held computers, as taught by this invention. There is a long-felt need for people to be able to download current consumer and travel data into a hand-held computer; and there is a long-felt need for people to be able to accomplish this download while in the process of either shopping or traveling. The prior art does not teach the distribution of hand-held computers to a plurality of consumers for download, while the consumer is shopping, of current purchasing information often required by a consumer. The prior art also does not teach the distribution of hand-held computers to a plurality of travelers for download, during the course of the traveler's trip, of current travel information often required by a traveler.

Another area where the availability of updated information and data is desirable is at a sporting event. Television coverage of sporting events has progressed to the point where attendees at a sporting event are frequently at a disadvantage to television viewers of the same event with regard to the availability of information regarding the event and the progress of play. For example, home viewers now frequently have access to live data and statistics, on demand, via the internet or interactive television services while watching a sporting event, and may be able to participate in interactive fan polls and the like. Although electronic devices such as cellular phones may technically be usable to receive data such as sports scores while at a given sporting event, the current devices each have disadvantages. For example, some current methods of providing user selected real time data rely on high cost portable computers provided by each individual attendee or that are temporarily loaned to the attendee. Other current methods and systems are open electronic systems that rely on outside cellular phone systems, requiring the attendees to pay periodic fees and charges per transmission, and that are susceptible to interference from outside signals. Still other current methods rely on closed systems that provide static data, and not real time data and do not enable participation in interactive activities. Those skilled in the art have failed to provide for systems and methods to distribute hand-held computers to a plurality of sporting event attendees in order to enable those attendees to transmit and receive real time data via a closed network within the location of the sporting event itself. Those skilled in the art have also failed to provide for a cost-effective method of implementing such a system wherein the hand-held computers provided to the attendees may be kept by the attendees after the event. The present invention fulfills these needs and provides further related advantages as described in the following summary.

### SUMMARY OF THE INVENTION

The present invention teaches certain benefits in construction and use that give rise to the objectives described below.

In accordance with an aspect of the present invention, a method for enabling attendees to retrieve data regarding a sporting event, on demand, during the sporting event and while at a local area within which the sporting event is being held, is provided. The method may include providing a central computer having a central processing unit, a memory unit, and a data input unit. The central computer may be installed at a location either within the local area or outside of the local area. Data related to the sporting event may be input into the central computer using the data input unit, and the data may be stored in the memory unit.

A data distribution node having a communication unit may also be provided within the local area, wherein the data distribution node is coupled to the central computer. The data distribution node may be a plurality of data distribution nodes installed at a plurality of locations within the local area. Alternatively, the data distribution node may be a portable wireless transceiver array configured for movement between a plurality of locations within the local area.

A hand-held computer may be provided to an attendee within the local area. The hand-held computer may include a central processing unit, a data storage unit, a data entry unit, a data transfer mechanism, and a display unit, wherein the data transfer mechanism is configured to transfer data between the hand-held computer and the data distribution node. A request for data related to the sporting event transmitted by the hand-held computer may be received by the transceiver of the data distribution node and relayed to the central computer by the data distribution node. The requested data relating to the sporting event may be retrieved from the memory unit based upon the request for data, and transmitted to the hand-held computer using the transceiver of the data distribution node. The requested data may then be displayed to the attendee using the display unit of the hand-held computer in such manner that the attendee is able to retrieve the requested data while within the local area of the sporting event.

In one embodiment of this method, the data related to the sporting event that is input into the central computer comprises real-time commentary related to the sporting event. This real-time commentary data may be broadcast into the local area in real-time and substantially continually during the sporting event using the transceiver of the data distribution node. The data may be received by the data transfer mechanism of the hand-held device, and then displayed the real-time commentary to the attendee using the display unit of the hand-held device.

A docking station may also be provided to the attendee. The docking station may have a first connection configured to interface with the hand-held computer and a second connection configured to interface with a computer.

In another aspect of the present invention, a method is provided that enables attendees at a local area within which a sporting event is being held to participate in an interactive activity during the sporting event using a hand-held computer. A central computer having a central processing unit, a memory unit, and a data input unit may be provided. Also, a data distribution node coupled to the central computer may be provided within the local area. The data distribution node may have a transceiver. An attendee may be provided with a hand-held computer having a central processing unit, a data storage unit, a data entry unit, a data transfer mechanism, and a display unit, wherein the data transfer mechanism is configured to transfer data between the hand-held computer and the data distribution node.

An inquiry related to the interactive activity may be transmitted into the local area using the transceiver of the data distribution node. Subsequently, a response to the inquiry from the attendee may be received, wherein the attendee enters the response into the hand-held computer, the data transfer mechanism of the hand-held computer transmits the response to the data distribution node, the data distribution node receives the response using the transceiver, and the data distribution node transfers the response to the central computer. The response may be processed using the central computer in order to generate a result. The result may then be transmitted to the hand-held computer using the transceiver of the data distribution node. After the hand-held computer receives the result, the result may be displayed to the attendee using the display unit of the hand-held computer.

The interactive activity to which this method relates may be a poll, in which case the inquiry comprises a question, and the response comprises an answer to the question. Here, processing of the response may include continuing to receive responses from attendees within the local area for a predetermined period of time. The responses from the attendees may include a plurality of different answers to the question. The responses may be stored in the memory unit of the central computer. At the end of the predetermined time, a result may be generated by tabulating the plurality of different answers using the central processing unit of the central computer, wherein the result includes a summary of the number of times each different answer was received from the attendees.

The interactive activity to which this method relates may also be a game, in which case the inquiry comprises an invitation to participate in the game, and the response comprises an entry for the game. When the interactive activity is a game, the processing of the response may include continuing to receive responses from the attendees for a predetermined period of time, and storing the responses in the memory unit of the central computer. At the end of the predetermined period of time, a result may be generated by selecting a winning response from the responses received from the attendees. The result may be either a single winning response or a plurality of winning responses.

In another aspect of the present invention, a method for enabling attendees to retrieve data regarding the sporting event and while at a local area within which the sporting event is being held is provided. A central computer comprising a central processing unit, a memory unit, and a data input unit may be provided. The central computer may be located inside the local area. Alternatively, the central computer may be situated outside of the local area. A data distribution node that includes a transmitter may be installed within the local area. The data distribution node is also coupled to the central computer. The data distribution node may comprise a plurality of data distribution nodes installed at a plurality of locations within the local area. The data distribution node may also comprise a portable wireless transmitter array configured for movement between a plurality of locations within the local area.

The attendees may be provided with a hand-held computer comprising a central processing unit, a data storage unit, a data entry unit, a data transfer mechanism, and a display unit, wherein the data transfer mechanism is a receiver. The receiver is configured to receive data that is broadcast by the data distribution node.

Data related to the sporting event may be input into the central computer using the data input unit. The data may be, e.g., real-time commentary related to the sporting event. The inputted data may be stored in the memory unit of the central computer. The transmitter of the data distribution node may be used to broadcast the data into the local area. The broadcasting of the data, which is related to the sporting event, may be performed substantially continually during the sporting event.

The data that is broadcast by the data distribution node may be received by the hand-held computer, using the data transfer mechanism of the hand-held computer. The data transfer mechanism may be a receiver. The data may then be stored in the data storage unit of the hand-held computer.

At least a portion of the data broadcast by the data distribution node may be retrieved from the data storage unit. The portion of the data retrieved is determined based upon a request entered into the data entry unit of the hand-held computer. The retrieved data may then be displayed to the attendee using the display unit of the hand-held computer, thereby enabling the attendee to retrieve the data while within the local area of the sporting event.

For either of the above embodiments, the method may also include coupling the central computer to a display located within the local area. The result may then be displayed to the attendees within the local area by using the central computer to present the result on the display.

In a different aspect of the present invention, a system for enabling attendees to retrieve data regarding a sporting event, on demand, while at a local area within which the sporting event is being held, is provided. The system may include a central computer having a central processing unit, a memory unit, and a data input unit. The central computer may be located within the local area. Additionally, the central computer may be configured to receive data regarding the sporting event while the sporting event or related events are in progress via the data input unit. The central computer may also be configured to transmit data to a hand-held computer while the sporting event is in progress via a data distribution node. In one embodiment, the central computer may be further coupled to a display within the local area, and the system may present data on the display as well as on hand-held receivers within the local area.

The system may include a data distribution node that has a communication unit. The data distribution node may be coupled to the central computer. In one embodiment, the data distribution node may be wirelessly coupled to the central computer. The data distribution node may also be located within the local area. Also, the data distribution node may be a portable wireless data distribution node configured to be moved between a plurality of locations within the local area while the sporting event is in progress. The system may include a plurality of data distribution nodes located at a plurality of locations within the local area. The communication unit of the data distribution node may be a transmitter and the data distribution node may be configured to substantially continuously broadcast data into the local area for reception by a receiver of a hand-held computer.

In addition, the system may include a plurality of hand-held computers. Each hand-held computer may include a central processing unit, a data storage unit, a data entry unit, a data transfer mechanism, and a display unit. The data transfer mechanism may be configured to transfer data between the hand-held computer and the data distribution node while the hand-held computer is located within the local area.

A primary objective of the present invention is to provide a data distribution network having advantages not taught by the prior art.

Another objective is to provide a data distribution network that can deliver current information directly to consumers and travelers while they are in the process of either purchasing goods or traveling away from home.

Another objective is to provide a data distribution network that can deliver data that is personalized to the individual user.

A further objective is to provide a data distribution network that provides hand-held computers that allow the user to carry the information with them for easy reference.

Other features and advantages of the present invention will become apparent from the following, more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the present invention.

FIG. 2 is a perspective view of the hand-held computer having an electrical contact connector.

FIG. 3 is a perspective and partially exploded view of a data distribution node operably connected to a cash register and a credit card reader, the data distribution node having a docking station for receiving one of the plurality of hand-held computers.

FIG. 4 is a perspective view of the hand-held computer showing a second embodiment of the hand-held data transfer mechanism, the hand-held data transfer mechanism, including a first transmitter/receiver that operates in cooperation with a second transmitter/receiver of the second embodiment of the data distribution node.

FIG. 5 is a block diagram of the consumer shopping embodiment of the invention.

FIG. 6 is a flow diagram showing the transmission of an electronic request from the hand-held computer to the central computer and the transmission of an electronic response back to the hand-held computer.

FIG. 7 is a block diagram of a flight data system embodiment of the present invention.

FIG. 8 is a block diagram of an electronic concierge system embodiment of the present invention.

FIG. 9A is a block diagram of a system suitable for use in a local area, such as a sporting event, in accordance with the present invention.

FIG. 9B is a block diagram of another system suitable for use in a local area, such as a sporting event, in accordance with the present invention.

FIG. 9C is a block diagram of another system suitable for use in a local area, such as a sporting event, in accordance with the present invention.

FIG. 10A is a flow chart illustrating a process of enabling an attendee at a sporting event to retrieve data related to the sporting event on demand using a system as shown in any of FIGS. 9A-9C, in accordance with the present invention.

FIG. 10B is a flow chart illustrating a process of enabling an attendee at a sporting event to retrieve data related to the sporting event that is substantially continuously broadcast into the local area using a system as shown in any of FIGS. 9A-9C, in accordance with the present invention.

FIG. 11 is a flow chart illustrating a process of enabling an attendee at a sporting event to participate in interactive activities while at the sporting event using a system as shown in any of FIGS. 9A-9C, in accordance with the present invention.

FIG. 12A illustrates a docking station suitable for use with any of the systems shown in FIGS. 9A-9C, in accordance with the present invention.

FIG. 12B illustrates another docking station suitable for use with any of the systems shown in FIGS. 9A-9C, in accordance with the present invention.

### DETAILED DESCRIPTION OF THE INVENTION

The present invention provides for a data distribution network 10 for distributing data. The data distribution network 10 stores up-to-date or real-time data in a central computer 20, and disseminates the data through a plurality of data distribution nodes 30 to a plurality of hand-held computers 40. The data distribution network 10 distributes current or even real-time data to consumers and travelers directly to the location where the consumers and travelers are likely to require the data. In one embodiment, the data distribution network 10 can function completely automatically, in real-time, without any effort or expertise on the part of the consumer or traveler. The data distribution network 10 enables several novel methods, described below, of attracting and retaining consumers to a specific commercial location and travelers to a specific hotel or travel agency.

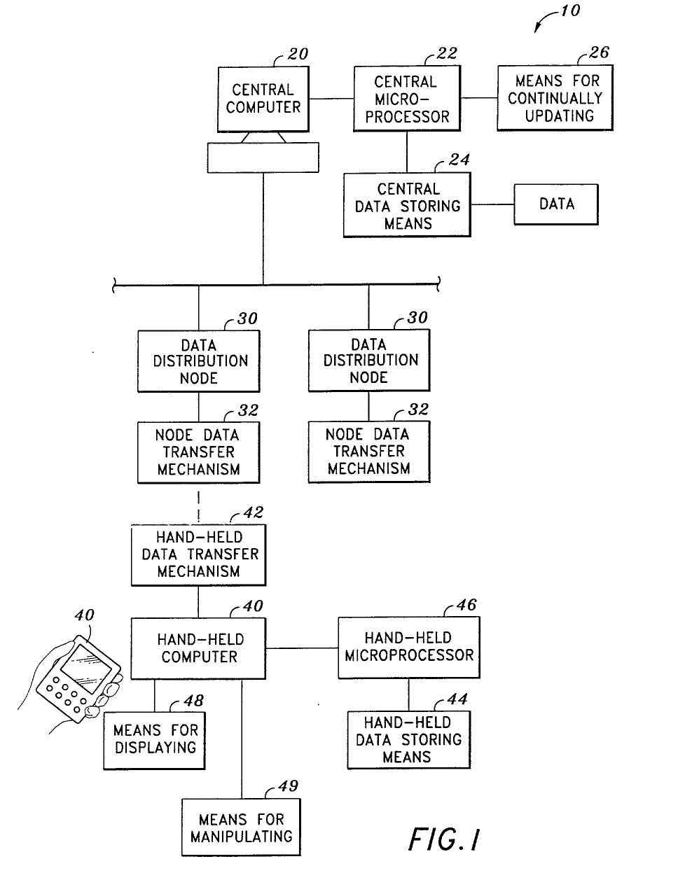

As shown in FIG. 1, the data distribution network 10 relies on the central computer 20 to store and maintain the data. The central computer 20 has a central microprocessor operably connected to a central means for storing the data 24. In a preferred embodiment, central computer 20 is a server or personal computer having a CPU, RAM, ROM and a hard drive, all operably connected by a motherboard (not shown). The central computer 20 further has a means for updating the data 26. Most of the data that is discussed herein is already maintained somewhere in an existing computer network; therefore, the data updating means 26 is preferably an operable connection to many other external computer networks with software necessary to transfer the current data into the central storing means of the central computer 20. In alternative embodiments, the data updating means 26 is a keyboard and mouse, or some other well known data entry mechanism. Since computers, computer networks, data updating means 26, and similar devices and systems are well known to those skilled in the art, they are not discussed at length herein.

As shown in FIG. 1, the data distribution network 10 uses the plurality of data distribution nodes 30 to transmit the data from the central computer 20 to the plurality of hand-held computers 40. Each of the plurality of hand-held computers 40 has a hand-held data transfer mechanism 42, and a hand-held means for storing the data 44 operably connected to a hand-held microprocessor 46. The hand-held data transfer mechanism 42 is discussed in more detail below. The hand-held means for storing the data 44 is preferably a memory chip operably connected to a hand-held microprocessor 46, both well known in the art. Each of the plurality of hand-held computers 40 further has a means for displaying 48 the data and a means for manipulating 49 the data. The means for displaying 48 the data is preferably an LCD screen electronically connected to the memory means through an LCD driver chip (not shown), although many equivalent displays are well known in the art. In a first embodiment, the data manipulation means 49 is a keypad, either with an entire “qwerty” keyboard, or a reduced size keypad, designed to navigate a series of menus. In a second embodiment, the data manipulation means 49 is a microphone electronically connected to the hand-held computer 40, the hand-held computer 40 having a means for converting sound (not shown) into computer commands.

The plurality of data distribution nodes 30 are operably connected to the central computer 20, preferably through a global communications network such as the Internet™ or an equivalent network. Establishing such a connection is well known to those skilled in the art. It is not essential that the operable connection maintain a constant flow of data —the connection can be made temporarily on a periodic basis for the purpose of updating data. In one embodiment, each of the plurality of data distribution nodes 30 is a computer having a CPU, RAM, ROM and a hard drive, all operably connected by a motherboard as described above. By providing the data distribution node 30 with a hard drive, the data distribution node 30 is able to store data for retrieval, thereby eliminating the requirement of a permanent connection to the central computer 20.

Each of the data distribution nodes 30 has a node data transfer mechanism 32 for transferring the data from the central computer 20 to the hand-held data transfer mechanism 42 of one of the hand-held computers 40 in response to a request from the hand-held data transfer mechanism 42. The node data transfer mechanism 32 cooperates with the hand-held data transfer mechanism 42 to operably connect one of the data distribution nodes 30 to the hand-held computer 40 that is requesting data.

In a first embodiment, as shown in FIG. 3, each of the plurality of data distribution nodes 30 include a docking station 34 adapted to receive one of the plurality of hand-held computers 40. In this first embodiment, the node data transfer mechanism 32 is a first electrical contact connector, and the hand-held data transfer mechanism 42 is a second electrical contact connector. When the hand-held computer 40 is inserted into the docking station 34, the first electrical contact connector 32 forms an electronic connection with the second electrical contact connector 34, thereby allowing the hand-held computer 40 to communicate with the data distribution node 30. The benefit of the first embodiment is that large amounts of data can be transferred very quickly to the hand-held computer 40 with relatively inexpensive equipment.

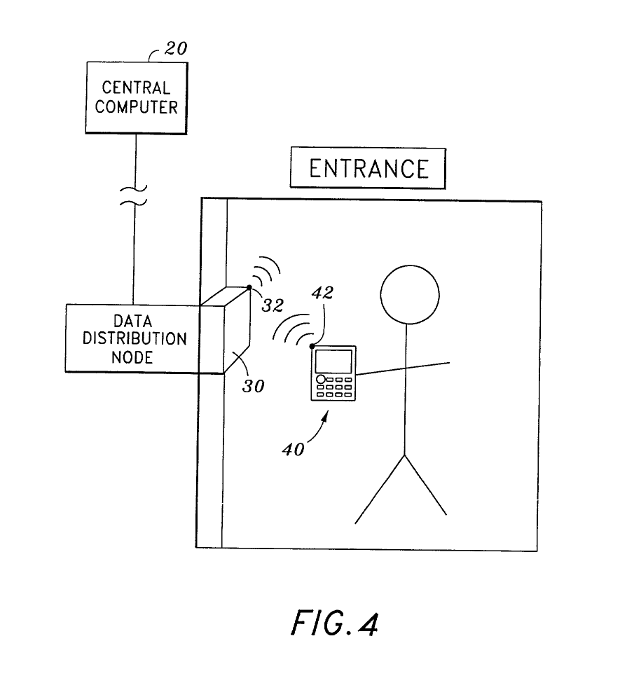

In a second embodiment, as shown in FIG. 4, the hand-held data transfer mechanism 42 is a first transmitter/receiver electronically connected to the hand-held computer 40, and the node data transfer mechanism 32 is a second transmitter/receiver electronically connected to the data distribution node 30. The operative connection between the first and second transmitter/receivers 42 and 32 enables electronic communication between each of the plurality of hand-held computers 40 and the central computer 20 through the data distribution node 30 that is closest to the hand-held computer 40. In the preferred embodiment, each of the plurality of data distribution nodes 30 at least periodically emits an identification signal that alerts any of the plurality of hand-held computers 40 within range that the hand-held computer 40 is within range. In this embodiment, the hand-held computer 40 has a means to automatically transmit the request to the nearest data distribution node 30 once the hand-held computer 40 receives the identification signal. This allows the hand-held computer 40 to immediately update the data itself without waiting for the user to initiate the transfer.

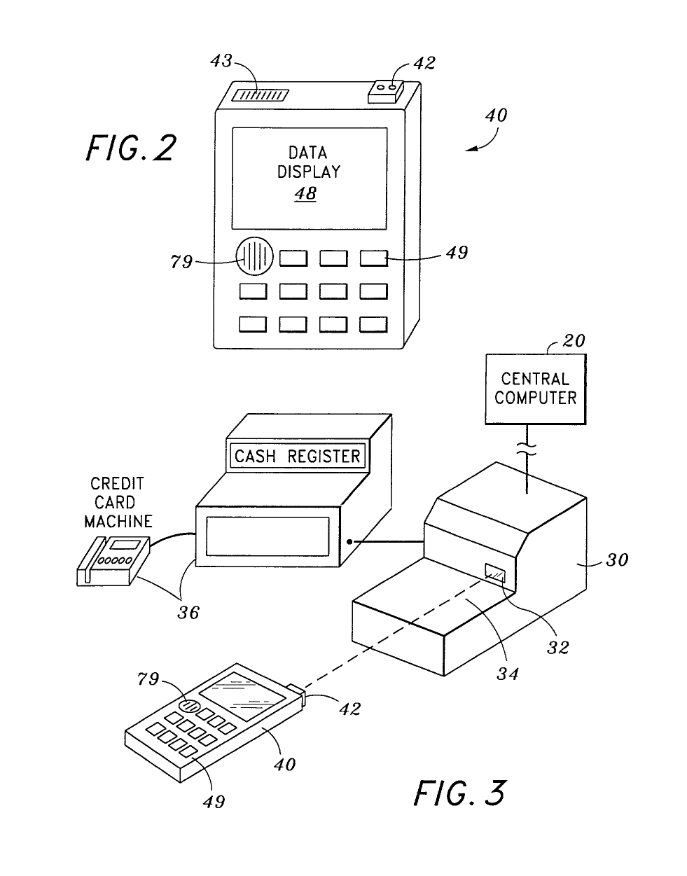

In another embodiment, as shown in FIG. 2, each of the plurality of hand-held computers 40 further includes a smart label 43 that reflects the identification signal to form a reflected signal that is unique to each of the hand-held computers 40. The receipt of the reflected signal by the data distribution node 30 is reported to a report database 52 of the central computer 20. In either embodiment, it is desirable to provide the central computer 20 with a report database 52 so that the system administrators can track the buying habits of the users.

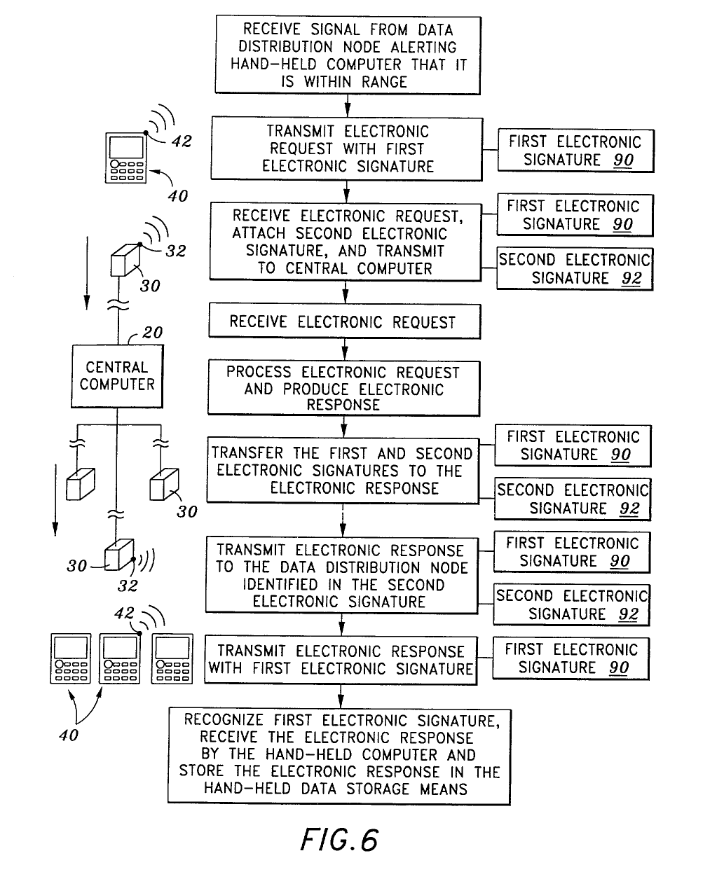

When using the first and second transmitter/receivers 42 and 32, it is necessary to develop a system of tracking which of the plurality of hand-held computers 40 sent the data request and which of the data distribution nodes 30 received the data request. In the preferred embodiment, as shown in FIG. 6, each of the hand-held computers 40 transmits an electronic request to the data distribution node 30 with a first electronic signature 90 that identifies the hand-held computer 40 that is transmitting the electronic request. The electronic request is delivered to the central computer 20 with a second electronic signature 92 that is unique to that particular data distribution node 30. The second electronic signature 92 identifies the location of the data distribution node 30 that delivered the electronic request. Once the electronic request has been processed by the central microprocessor 22, the electronic response that has been prepared is delivered from the central computer 20 to the data distribution node 30 identified in the second electronic signature 92. The electronic response is transmitted from the second transmitter/receiver 32 of the data distribution node 30 and routed to the hand-held computer 40 that sent the electronic request as directed by the first electronic signature 90. The electronic response can then be stored in the hand-held data storing means 44 and displayed on the display screen.

Consumer Loyalty System

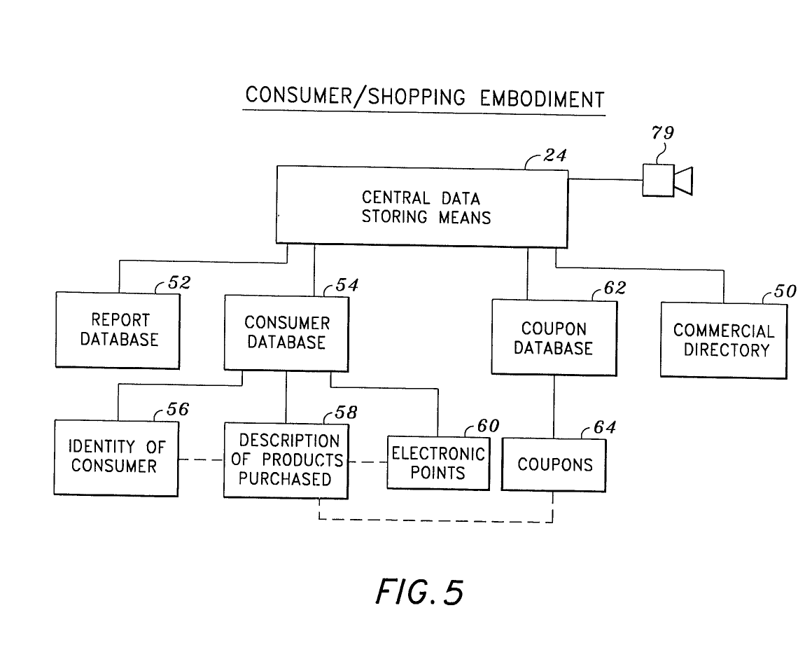

As shown in FIG. 5, the invention includes a method for interacting with, exchanging data with, and rewarding a consumer. The method utilizes the data distribution network 10 described above to encourage the consumer to remain loyal to a commercial location such as a shopping mall. Each of the data distribution nodes 30 is installed in publicly accessible locations within or in proximity to the commercial location. Likely locations include entrances and kiosk locations throughout a mall or shopping center. Each of the data distribution nodes 30 is operably connected to the central computer 20, preferably with standard cables, although wireless configurations are also possible and well within the skill of those skilled in the art. Each of the plurality of hand-held computers 40 is distributed to one of the consumers. Various promotional programs can be devised by marketing professionals to either sell or give away the hand-held computers 40 to people who are likely to shop in the commercial location.

When the consumer enters the commercial location, the hand-held data transfer mechanism 42 of the hand-held computer 40 is operatively connected with the node data transfer mechanism 32 of the closest of the plurality of data distribution nodes 30. This can be accomplished with any of the above-described methods, preferably by automatically downloading at least a portion of a commercial directory 50 through the data distribution node 30 to the hand-held data storing means 44. The commercial directory 50 includes basic information about the commercial location such as a map of the location, which items are on sale and where the items are located. This commercial directory 50 is preferably made available to consumers so that they are able to gather data and have questions answered directly from their hand-held computer 40.

In the preferred embodiment, the central computer 20 further includes a report database 52. The data distribution network 10 automatically tracks the movement of the consumer through the commercial location, recording how much time is spent in each area of the commercial location. Those skilled in the art can devise countless methods for improving such a system, including GPS systems and triangulation between the data distribution nodes 30. The data gathered from this aspect of the system is stored in the report database 52 for later reference and use. The central computer 20 is then able to interact with the consumer based on the “memory” of the central computer 20 as to where the consumer is located within the commercial location and what he or she has been doing within the commercial location.

In the preferred embodiment, the central computer 20 further includes a consumer database 54. The consumer database 54 stores an identity of each consumer 56 with a description of products purchased 58 by that consumer and a plurality of electronic points 60 associated with the consumer. To gather and associate the data required for this embodiment, the data input means 36 is preferably a cash register electronically connected to one of the data distribution nodes 30. Once the consumer has selected the products he or she would like to purchase, the description of products purchased 58 in inputted through the cash register into the consumer database 54. The hand-held computer 40 is then operably connected with the data distribution node 30, preferably through a docking station 34 as described above, so that the identity of the consumer 56 making the purchase can be transmitted to the central computer 20 for proper association with the description of the products purchased 58. This data allows a plurality of electronic points 60 to be awarded to the consumer in proportion to the value of the products purchased. The plurality of electronic points 60 is added to any other electronic points 60 already earned and the sum is recorded in the consumer database 54. Those skilled in marketing can devise multiple marketing schemes that allow the value of the accumulated electronic points 60 to be exchanged for a reward of some sort. Such a reward acts as an incentive for the consumer to accumulate the electronic points 60 by making their purchases at the commercial location.

In another embodiment of this invention, the method preferably further includes a coupon database 62 containing a plurality of coupons 64. When the hand-held computer 40 transmits the data request, the central computer 20 locates the identity of the consumer, references the description of products purchased 58 associated with that consumer, and compares the description of products purchased 58 with a plurality of coupons 64 available in the coupon database 62. The plurality of coupons 64 that are determined to be similar to the description of products purchased 58 are then offered to the consumer as an incentive to purchase additional goods at the commercial location. In an alternative embodiment, the central computer 20 transmits a random sampling of some of the plurality of coupons 64 available in the coupon database 62 without restricting the coupon availability to those that are somehow related to the user.

Another important aspect of this invention is that the combination of the above-described features allows even further innovation. For instance, the central computer 20 can “learn” about the buying habits of the consumer based on the report database 52 and the consumer database 54, marketing efforts such as special coupons from the coupon database 62 can be directly targeted to the consumer. Those skilled in the marketing profession can devise many special programs to be used within the framework of this invention without deviating from the inventive spirit of the invention described herein.

Flight Data System

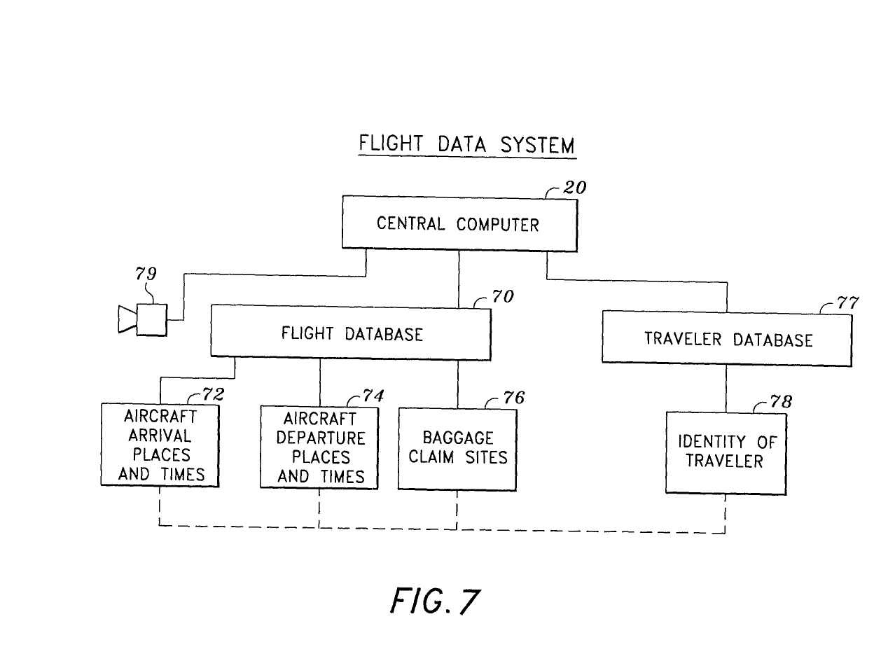

As shown in FIG. 7, the invention also includes a method for distributing flight data to a traveler. While we refer specifically to flight data for airlines, it should be understood by those skilled in the art that the system is equally useful for a variety of forms of transportation, including busses, ferries, trains, boats, etc. These alternative embodiments are expressly considered equivalent to the embodiment described herein. In this embodiment, the central data storing means 24 is programmed to store a flight database 70 and a traveler database 77. The flight database 70 contains a plurality of aircraft arrival places and times 72 and a plurality of aircraft departure places and times 74. In its preferred embodiment, the flight database 70 also includes a plurality of baggage claim sites 76.

The traveler database 77 containing a plurality of identities of travelers 78. Those skilled in the art will recognize that the consumer database 54 can function as the traveler database 77. When a ticket is prepared for the traveler, the airplane ticket is associated with one of the plurality of aircraft departure places and times 74, one of the plurality of aircraft arrival places and times 72, and one of the baggage claim sites 76. The identity of the traveler 78 is inputted into the flight database 70 and associated with the aircraft departure time and place 72, the aircraft arrival time and place 74, and the baggage claim site 76 associated with the ticket purchased by the traveler. The data distribution nodes 30 are preferably installed in publicly accessible locations within an airport, thereby allowing the traveler to access the flight database 70 on a regular basis to review the current aircraft departure time and place 72, the current aircraft arrival time and place 74, and the baggage claim site 76.

In the most preferred embodiment, the hand-held computer 40 automatically signals the central computer 20 when the traveler enters the airport. The central computer 20 can then compare the identity of the traveler 78 with the associated flight arrival places and times 74 and the flight departure places and times 72 and alert the traveler if there have been any changes to the associated flight arrival places and times 74 and the flight departure places and times 72. In this embodiment, the hand-held computer 40 further includes a means of warning the traveler 79, such as a speaker that emits an audible tone if there has been a change in his or her schedule. In an alternative embodiment, the central computer 20 advises the airline reservation and ground services department of the arrival of a passenger and permit the people to contact the passenger through the central computer 20 via the hand-held computer 40. There are many specific uses that can be devised for this system by those skilled in the art, and obvious variations of the above-described system are considered equivalent to the best mode described herein.

Electronic Concierge System

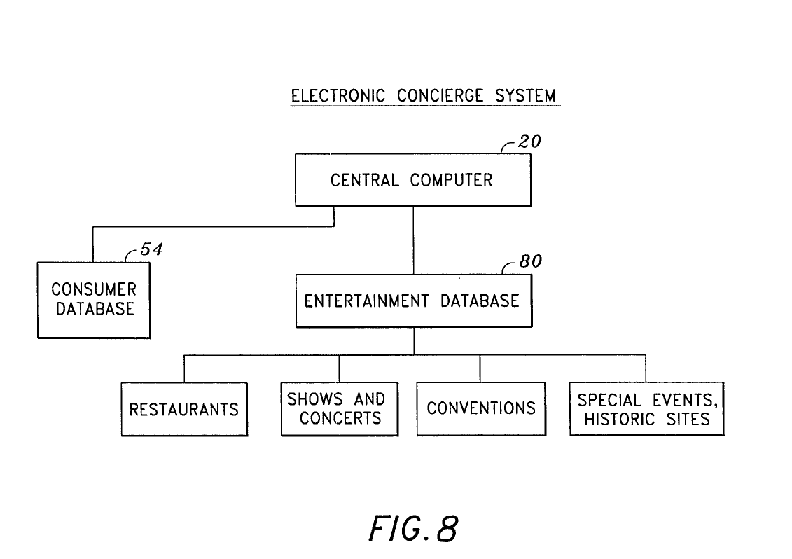

As shown in FIG. 8, the invention further includes a method for providing an electronic concierge service to at least one hotel guest. In this embodiment, the central computer 20 is programmed with an entertainment database 80. When a hotel guest is checked into the hotel, he or she is provided with the hand-held computer 40 described above. At least one data distribution node 30 is installed in the hotel for updating the hand-held computer 40 as described above. An employee is then responsible for inputting into the entertainment database 80, on a regular basis, entertainment information of interest to the hotel guest. The entertainment database 80 preferably includes a list of restaurants, shops, shows, concerts, conventions, special events, historic sites or other sites of interest to tourists. The entertainment database 80 preferably includes information about prices, menus, special discounts and other specialty information. In the preferred embodiment, the central computer 20 can also facilitate the purchase of tickets to the various events, preferably at discounted rates. The discounted rates can be provided by either taking advantage of commercially available coupons or special engagements, or the hotel can negotiate special rates for its guests.

In the preferred embodiment, the central computer 20 of this embodiment further includes the consumer database 54 described above. The consumer database 54 allows the system to track users and customize data to suit the needs of the individual consumer, as well as return valuable marketing data about the consumer. As noted above, those skilled in the art can devise countless marketing programs around the novel capabilities of this system.

Travel Agency Data Distribution System

In its more complex embodiment, the invention can include many of the above-described embodiments and be administered by a travel agency or similar company to provide a traveler with a great deal of information throughout his or her travels. Such an embodiment would preferably include, at a minimum, a traveler database 77, a flight database 70, and an entertainment database 80 as previously described. The data distribution network 10 preferably further includes news, alerts, and other data information of interest to travelers, especially those traveling to other countries. One particular benefit of having a travel agency manage the data distribution network 10 is that they would have the economic clout to negotiate special deals throughout the world and allows the traveler to purchase many tickets before traveling and with U.S. dollars, thereby avoiding difficulties in changing money.

All of the data can be centrally managed and updated for real-time or near real-time distribution to thousands of travelers. By bringing the data under central and professional management, the individual traveler can receive all of the benefits of a major travel agent in real time and at his or her fingertips. Furthermore, it is expected that the several embodiments will be compatible so that the hand-held computer 40 of one embodiment may respond to the signals of different central computers 20.

All of the above embodiments include advertising indicia printed or otherwise marked on the hand-held computer 40 or generated by the display of the hand-held computer 40. The advertising indicia is sold to relevant sponsors; and the money generated by the sale either defrays or entirely eliminates the cost of manufacturing the hand-held computer 40.

Sporting Events Data Distribution and Interaction System

The present invention also provides for systems and methods that enable attendees at a sporting event to retrieve data related to the sporting event, on demand and in real time, and to participate in interactive activities such as polls and attendee participation games while at the sporting event, using a closed data network.

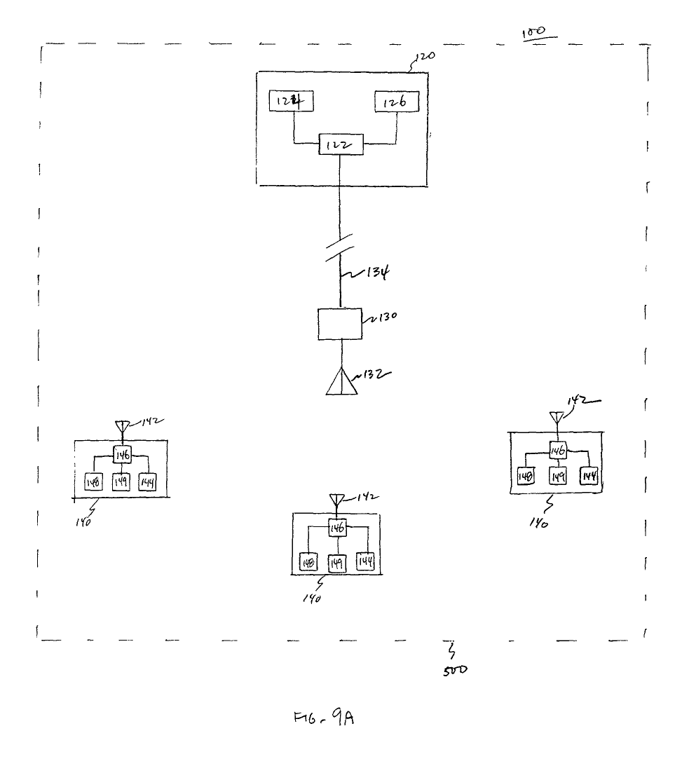

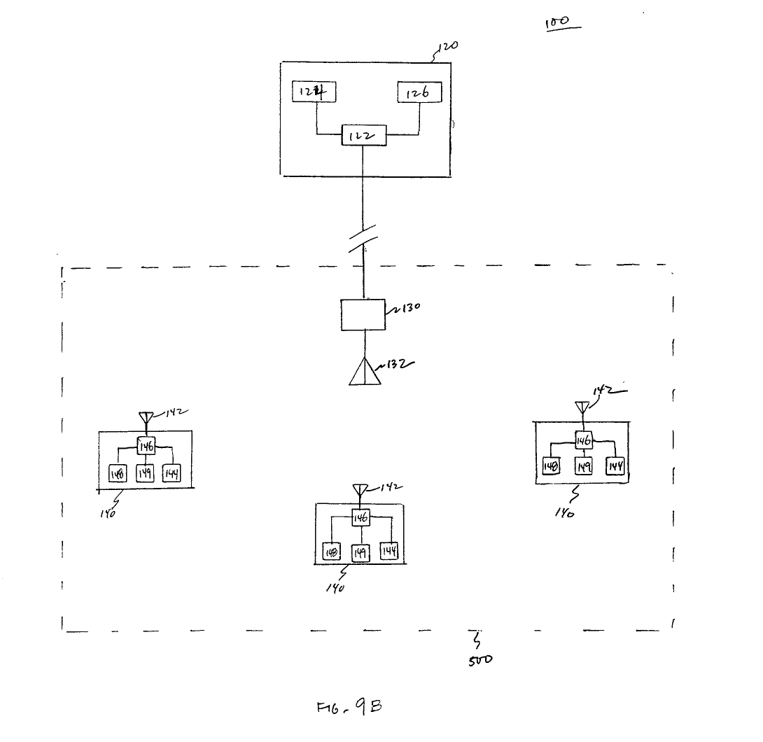

Turning to FIGS. 9A-9C, a data distribution system 100 suitable for use in a sporting event setting is shown. The system 100 is suitable for use with such varied sporting events as vehicle racing events, golf tournaments, horse and dog racing, football, soccer, baseball, basketball, volleyball, and the like. Accordingly, the data that the system 100 is capable of delivering to the attendees varies by the type of sporting event with which the system 100 is used. For vehicle racing events, the system 100 may transmit pre-race information such as name of driver, crew, or team, name of sponsor, number of vehicle, description of vehicle, statistical and historical data on driver, sponsor, car, race track, and race series, including Formula One, Winston Cup, Busch, CART, motorcycle championship series, American LeMans series, sailboat regattas, midget car races, aircraft races, powerboat races, and the like, order of starting position, qualifying times, and the like. The system 100 may also transmit real-time information such as, e.g., commentary, running order, lap times, pit times, laps since pitting, instantaneous speeds, intervals between racers, position on track or course, and the like. For golf tournaments, the system 100 may transmit pre-start information such as list of players, list of pairings, order of start, time of start, handicaps, statistical and historic information on players, caddies, golf course, sponsors, past scores, and the like. The system 100 is also capable of transmitting real-time play progress, scores, and commentary, such as individual player, team, or group score, position on the course, selection of club, distance to the pin, relationship to hazard or impediment to play, and the like. For horse and dog racing, the system 100 is capable of transmitting pre-race information that includes order of start, pre-race odds, name ofjockey, name of sponsor, number of animal, description of animal, statistical and historical information on animal, jockey, track and race series, such as Kentucky Derby, Preakness, Belmont Stakes, and the like. The system 100 may also transmit real-time information and commentary, including running order, instantaneous speeds, intervals between racers, position on track or course, and the like. When used with football, baseball, basketball, soccer, volleyball and similar events, the system 100 is capable of transmitting pre-game information that includes starting lineups, name of players, crew or team, name of sponsor, identifying numbers of players, description of players, statistical and historical data on players, teams, and leagues such as professional leagues, collegiate leagues, high school leagues, little leagues, and the like. Also, the system 100 may transmit real-time information and commentary that includes score, time remaining, time outs remaining, rulings by officials, players participating at a given time, and the like. For any sporting event, the system 100 is usable to allow an attendee to participate in interactive promotions, such as responding to event organizer surveys, providing input regarding rulings by event officials, and participating in games of chance, raffles, lotteries, drawings, and the like.

The system 100 is preferably used within a local area 500 in which the sporting event is taking place. For the sake of brevity, the term local area will be used herein to refer to the arena, stadium, track, course, and the like, in which the system 100 is used to provide specific event-related data to the attendees. Within the local area 500, the system 100 may also be used to enable the attendees to transmit data to the system 100 to participate in interactive activities including polls, promotions, games, and contests, in addition to enabling the attendees to retrieve data related to the sporting event on demand.

The system 100 includes a central computer or server 120. The central computer 120 may be any suitable personal computer or server that is capable of maintaining a database and data related to a sporting event. The central computer 120 is also capable of operating at least one data distribution node 130 in order to interact with a plurality of hand-held computers 140 located within the local area 500. Preferably, the central computer 120 includes a central processing unit 122, at least one memory unit 124 coupled to the central processing unit 122, and a data input unit 126 coupled to the central processing unit 122. The memory unit 124 is used to maintain any necessary databases and for storage of data. The memory unit 124 may be any suitable memory-related device or component, including, e.g., random access memory (RAM), flash memory, non-volatile EEPROM, a hard drive, other disk drives, and the like. The data input unit 126 may be any suitable input device or component capable of being used to input and provide statistical data, historical data, commentary, real-time progress of play data, and the like, to the central computer 120. Exemplary input devices and components usable for the data input unit 126 include, e.g., keyboards, mice, a modem, a network interface card or other operable connection to another computer or network, a transceiver, and the like.

In the embodiment of system 100 shown in FIG. 9A, the central computer 120 is maintained at a location within the local area 500. In another embodiment, as seen in FIG. 9B, the central computer 120 is installed at a remote location and communicates with data distribution nodes 130 that are installed within the local area 500 either wirelessly or via hard data lines.

The system 100 includes at least one data distribution node 130. As illustrated in FIGS. 9A and 9B, the system 100 has one data distribution node 130 installed within the local area 500. In other embodiments of the system 100, a plurality of data distribution nodes 130 are provided throughout the local area 500. Each data distribution node 130 is preferably an electronic device or component suitable for transmitting and receiving data to and from the central computer 120, as well as transmitting and receiving data to and from a hand-held computer 140, which will be discussed. Each data distribution node 130 may also be configured to only transmit data to a hand-held computer 140, instead of also receive data from a hand-held computer 140.

Each data distribution node 130 may be a computer, server, an antenna repeater, or antenna array. Each data distribution node 130 is coupled by a transmission connection 134 to the central computer 120. The transmission connection 134 may be a wireless connection, wherein the data distribution node 130 and the central computer 120 transmit data via wireless transmitters and receivers or wireless transceivers (not shown). The transmission connection 134 may also be a hard wire connection, such as, e.g., an optical data line, a cable line, a coaxial cable, and the like. Each data distribution node 130 may also include a communication unit 132, which enables each data distribution node 130 to wirelessly transmit and/or receive data to and from the hand-held computers 140 within the local area 500. In one embodiment, the communication unit 132 is a transceiver, and the data distribution node 130 is configured to both transmit and receive data to and from the hand-held computers 140. In another embodiment, the communication unit 132 is a transmitter, and the data distribution node 130 transmits data to, but does not receive data from, the hand-held computers 140. The data distribution node 130 may be installed at any number of locations within the local area 500. For example, when the system 100 is used within a sport arena, a single data distribution node 130 may be installed in the main scoreboard. Alternatively, a plurality of data distribution nodes 130 may be placed at various locations within the arena, instead of or in addition to installing a data distribution node 130 in the main scoreboard. The data distribution nodes 130 may be permanently installed within the local area 500. The data distribution nodes 130 may also be portable wireless transceiver or transmitter arrays that may be moved between various positions within the local area 500. Moving the data distribution nodes 130 between various locations within the local area 500 may be desirable, for example, to accommodate various arena configurations or to adjust the positions of the nodes 130 relative to varying concentrations of attendees within the local area 500. Movement of the data distribution nodes 130, when the nodes 130 are portable, may also be accomplished while the sporting event is in progress, if desired.

The hand-held computers 140 are similar to the hand-held computers 40 previously described. For example, each hand-held computer 140 includes a data transfer mechanism 142, a data storage unit 144, a display unit 148, and a data entry unit 149, which are all operably connected to a central processing unit 146. The data transfer mechanism 142 may be similar to the hand-held data transfer mechanism 42 of hand-held computer 40, and reference is made to the discussion of mechanism 42 as that description may also apply to data transfer mechanism 142. In one embodiment, the data transfer mechanism 142 may be a transceiver suitable for wirelessly transmitting and receiving data to and from a data distribution node 130. In another embodiment, the data transfer mechanism 142 may be a receiver and the hand-held computer 140 receives data from a data distribution node 130 but does not transmit data to a data distribution node 130. The data storage unit 144 may be any memory chip or memory card capable of storing both permanent and temporary data. The display unit 148 is similar to display means 48 of hand-held computer 40, and reference is made to the description of display means 48. The data entry unit 149 may be a keypad, a keypad including a point and click selection mechanism such as a roller ball, roller pad, joystick, a point and click mechanism without a keypad, a microphone, or other suitable data entry component that enables a user to navigate a series of menus and to enter data into the hand-held computer 140 for transmission to a data distribution node 130.

Additionally, advertising indicia (not shown) may be associated with each hand-held computer 140. For example, the advertising indicia may be placed on an exterior surface of the hand-held computer 140 using labels or by physically imprinting the indicia on the surface. The advertising indicia may also be messages generated by the hand-held computer 140 and presented to the attendee on the display unit 148. To defray any costs associated with distributing the hand-held computers 140 to attendees, wherein the attendees are allowed to keep the hand-held computers 140 after the event, sponsors may be charged an appropriate fee for the opportunity to place a sponsor-related advertising indicia on the hand-held computers 140, or have advertising indicia messages displayed on the display unit 148 of the hand-held computers 140. In one embodiment, the advertising indicia associated with the hand-held computers 140 are from a single sponsor. In another embodiment, a plurality of advertising indicia related to a plurality of sponsors is associated with the hand-held computers 140. The hand-held computers 140 may include a single type of advertising indicia, such as, e.g., either advertising indicia placed on an exterior surface or advertising indicia presented on the display unit 148. Alternatively, the hand-held computers 140 may include both advertising indicia on an exterior surface and advertising indicia presented on the display unit 148.

Turning now to FIG. 9C, an embodiment of the system 100 is illustrated wherein the central computer 120 of the system 100 is coupled to a display 128. The display 128 may be, e.g., a scoreboard or other large display within the local area 500. Here, the system 100 may present on the display 128 the results of polls or games in which the attendees within the local area 500 participate by using the hand-held computers 140 to provide their responses to a data distribution node 130, as will be discussed herein. The system 100 may also present other data on the display 128, such as, e.g., running commentary or progress of play data that is input into the central computer 120. As shown in FIG. 9C the central computer 120 is located within the local area 500. In addition, the embodiment of the system 100 having the central computer 120 located outside the local area 500, as illustrated in FIG. 9B, may also have the central computer 120 coupled to the display 128. For either embodiment, the central computer 120 may be coupled to the display 128 either wirelessly or via a hard wire connection.

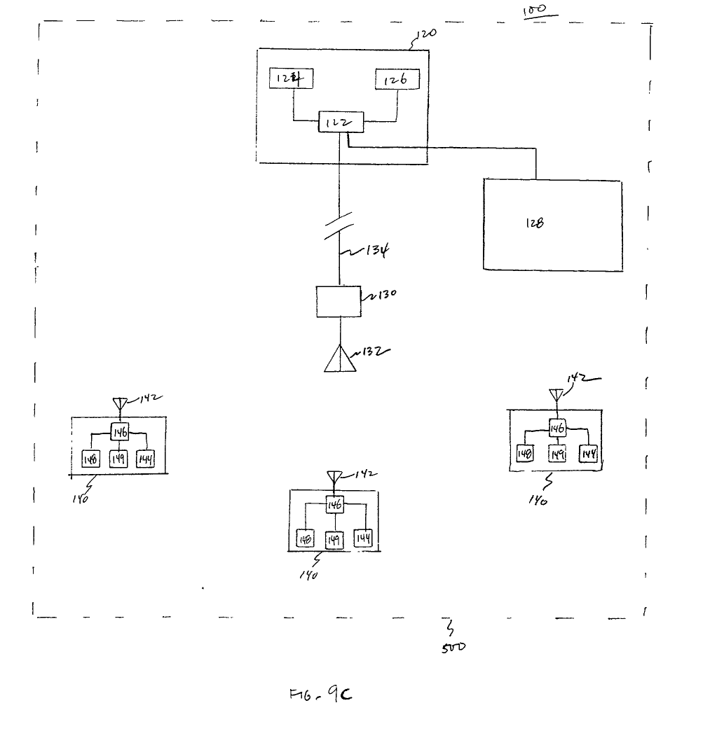

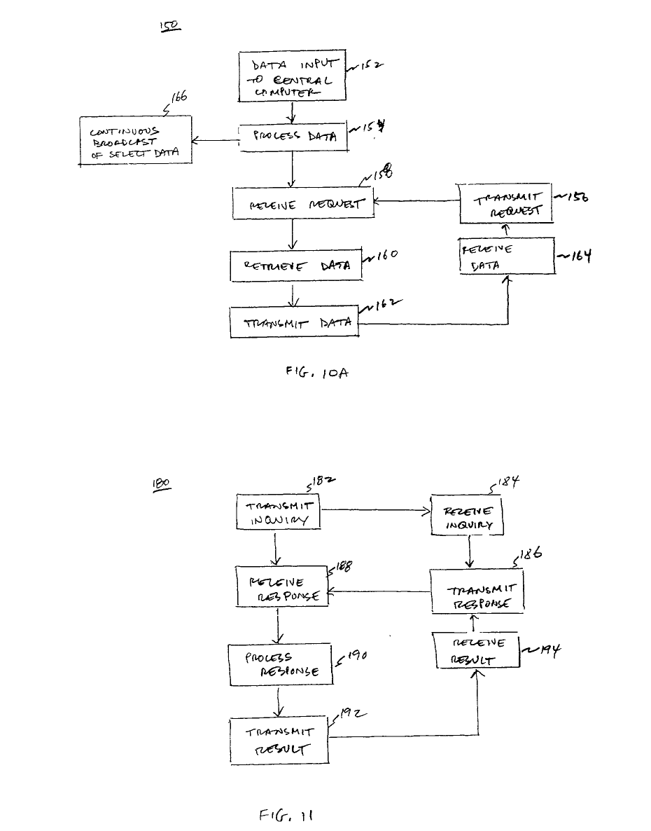

Turning to FIG. 10A, a flow chart illustrating a process for using the system 100 within a local area 500 to enable attendees to obtain real-time data regarding a sporting event, while at the sporting event, is shown. Initially, the system 100 is installed within the local area 500 as shown in either FIG. 9A or 9B. For example, the central computer 120 may be installed either outside of the local area 500, as shown in FIG. 9A, or at a location within the local area 500, as shown in FIG. 9B. One or more data distribution nodes 130 are then installed within the local area 500. Preferably, each data distribution node 130 includes a transceiver as the communication unit 132. Next, hand-held computers 140 are distributed to attendees of the sporting event. Like the data distribution nodes 130, each hand-held computer 140 used for this process preferably includes a transceiver as the data transfer mechanism 142. The distribution of the hand-held computers 140 may be accomplished in various ways, such as, e.g., the hand-held computers 140 may be given to the attendees as they enter the local area 500, the hand-held computers 140 may be placed on each seat within the local area 500 prior to the start of the sporting event, the hand-held computers 140 may be distributed from a plurality of stands through the local area 500, and the like. Alternatively, the attendees may use hand-held computers 140 obtained at a previous sporting event to interact with the central computer 120.

To enable attendees to retrieve real-time or on demand data regarding the sporting event, data is input into the central computer 120. (Step 152). For example, data and statistics regarding the sporting event, examples of which have previously been noted, as well as running commentary and progress of play data may be input into the central computer 120 using the data input unit 126. The data is then processed, such as, e.g., by storing the data in the memory unit 124 or within suitable databases that are maintained within the memory unit 124, for subsequent retrieval, and the data is encoded for transmission to the attendees. (Step 154).

When an attendee desires to retrieve data from the system 100, the attendee may request data from the central computer 120 by entering a data retrieval request in the hand-held computer 140 using the data entry unit 149. The hand-held computer 140 then transmits the data request, using the data transfer mechanism 142, from the attendee to a data distribution node 130. (Step 156). Here, the data transfer mechanism 142 is preferably a transceiver. The data distribution node 130 receives the data request from the attendee using the communication unit 132 and, in turn, relays the data request to the central computer 120. (Step 156). The central processing unit 122 of the central computer 120 receives the data request, processes the data request to determine the type of data requested, and retrieves the requested data from the memory unit 124. (Step 160). The central computer 120 then relays the requested data to the data distribution node 130, which transmits the data to the local area 500 using the communication unit 132. (Step 162). The data is then received by the data transfer mechanism 142 of the requesting attendee's hand-held computer 140 and presented to the attendee using the display unit 148. (Step 164). The hand-held computer 140 may store the requested data in the data storage unit 144 before, after, or both before and after presenting the requested data to the attendee. When the requested data is stored in the data storage unit 144, this data may later be transferred by the attendee to a computer via a docking station, which will be discussed herein.

The system 100 may also be used to continually broadcast running commentary and progress of play data within the local area 500. (Step 166). Here, the system 100 does not require a specific request from an attendee in order to provide running commentary and/or progress of play data. Instead, because the system 100 continually broadcasts the comment or progress data into the local area 500, a hand-held computer 140 may retrieve commentary or progress data without having to first transmit a data retrieval request to a data distribution node 130. As shown in FIG. 10A, the substantially continuous broadcast of commentary and progress of play data within the local area 500 (Step 166) is shown as an additional component of the process of using the system 100 to enable attendees to also retrieve data on command. The system 100 may also be used in a process wherein the attendees only receive the continuous broadcast of data, e.g., without having to specifically send a retrieve command to a data distribution node 130, and wherein the hand-held computers 140 are configured to only receive data and not transmit data. This process is illustrated in FIG. 10B. The process shown in FIG. 10B shares processing steps with the process shown in FIG. 10A. Accordingly, reference is made to the description of the process of FIG. 10A for the common elements that are present in the process of FIG. 10B. In one preferred method, running commentary and progress of play data is the data that is input into the central computer 120, using the data input unit 126, during the course of the sporting event. (Step 152). Unlike the process of FIG. 10A, where an attendee may optionally send specific retrieve requests to a data distribution node 130, the process of FIG. 10B only enables an attendee to receive data that is already being broadcast into the local area 500. As the data is broadcast into the local area 500 by the system 100, and specifically by a data distribution node 130 of the system 100, the hand-held computers 140 receive the data via the data transfer mechanism 142, which is preferably a receiver, and store the data in the data storage unit 144. (Step 167). To view the data stored in the data storage unit 144, the attendee enters a suitable request into the hand-held computer 140 using the data entry unit 149. The hand-held computer 140 then retrieves from the data storage unit 144 the data corresponding to the request entered by the attendee and displays the data on the display unit 148. (Step 169).

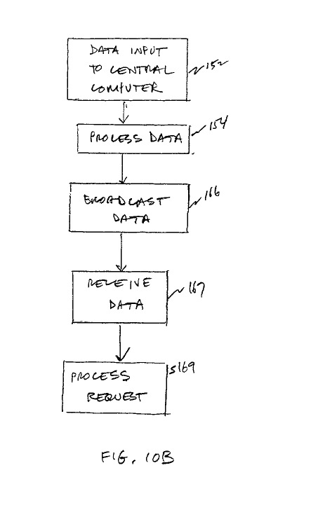

Turning to FIG. 11, a flow chart illustrates a process for using the system 100 within the local area 500 to enable attendees to participate in interactive activities, such as, e.g., games and polls, using hand-held computers 140 while attending the sporting event. Similar to the process shown in FIG. 10A, a variety of data may be input into the central computer 120, whereupon the central computer 120 may process and store the data for later use. (Steps not shown). When the system 100 is used for interactive activities conducted within the local area 500, the central computer 120 transmits an inquiry to a data distribution node 130, and the node 130 broadcasts the inquiry into the local area 500. (Step 182). The inquiry may be, for example, an invitation to participate in a poll or to participate in a game. The inquiry may then be received by the hand-held devices 140 within the local area 500. (Step 184). To participate in the poll or game, the attendee may enter an appropriate response to the inquiry into the hand-held computer 140 using the data entry unit 149. The response may be, for example, an answer to a poll or an entry for a game. The hand-held computer 140 then transmits the attendee's response to a data distribution node 130 using the data transfer mechanism 142. (Step 186). Accordingly, the data transfer mechanism 142 is preferably a transceiver. The data distribution node 130, or nodes 130 when the system 100 includes a plurality of nodes 130, receives the responses from the attendees, and relays those responses to the central computer 120. (Step 188). The central computer 120 then sorts and processes the responses. (Step 190).

The processing of the responses may vary depending on the type of inquiry originally broadcast by the central computer 120. For example, when the inquiry relates to a poll, the central computer 120 may receive the responses, sort the responses to generate poll results, and then broadcast the results into the local area 500 using the data distribution nodes 130, after, for example, allowing a sufficient, predetermined time for any interested attendees to participate, (Steps 190 and 192). A hand-held computer 140 may then receive the poll results and displays the results to the attendee on the display unit 148. (Step 194). It should also be appreciated that the poll results may be displayed concurrently on scoreboards located within the local area 500 when the central computer 120 is coupled to, e.g., a display 128.

Alternatively, when the initial inquiry relates to a game, the central computer 120 may receive the responses and, after allowing for a sufficient, predetermined time for any interested attendees to participate, analyze the responses to determine a winner or winners of the game, such as, e.g., by determining correct answers submitted in response to a question and identifying a winner or winners from the attendees who submitted a correct answer, or by randomly determining a winner or winners from the attendees who submitted a response. (Step 190). After determining the winner or winners of the game, the central computer 120 then broadcasts the results of the game, i.e., the identities of the winner or winners, to the local area 500 using the data distribution nodes 130. (Step 192). The results are received by the hand-held computers 140 and displayed to the attendees using the display units 148. (Step 194). As with polls, the results of the game may also be simultaneously displayed on scoreboards throughout the local area 500 when the central computer 120 is coupled to a display 128.

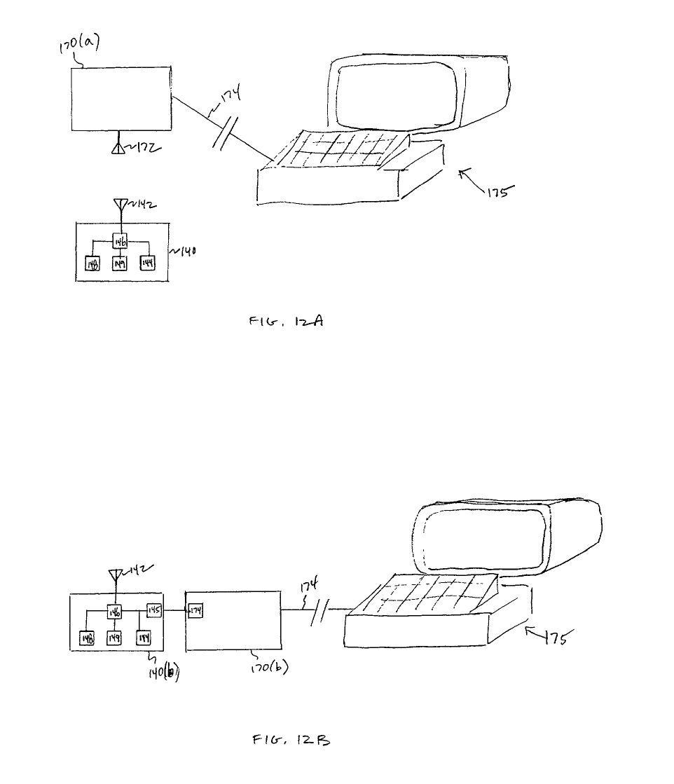

Turning to FIGS. 12A and 12B, the present invention may also include a docking station 170(a), 170(b) that enables an attendee to couple a hand-held computer 140, 140(b) to a computer 175 after the attendee leaves the local area 500. The computer 175 may be any computer to which peripherals may be attached, such as, e.g., a desktop computer, a laptop computer, a personal digital assistant, and the like. In one embodiment, docking station 170(a), shown in FIG. 12A, includes a wireless data transfer mechanism 172 coupled to the central processing unit 146 that enables data to be transferred wirelessly between the docking station 170(a) and a hand-held computer 140. The wireless data transfer mechanism 172 may be a transceiver. In another embodiment, docking station 170(b), shown in FIG. 12B, includes a connector 174 that may be physically coupled with a matching connector 145 provided in a hand-held computer 140(b). Hand-held computer 140(b) is substantially similar to hand-held computer 140, but also includes the matching connector 145. The connector 174 and matching connector 145 may be matching electrical contact connectors. Alternatively, the connector 174 and matching connector 145 may be, respectively, a parallel port and parallel connector, a serial port and serial connector, a USB port and USB connector, a firewire port and firewire connector, and the like. Both docking stations 170(a) and 170(b) may be coupled to the computer 175 using a suitable connection 174. For example, the types of interfaces usable for the connection 174 between the docking station 170(a), 170(b) and the computer 175 include a parallel connection, a serial connection, a USB connection, a firewire connection, a wireless connection, and any other suitable connection that enables data to be transferred between the docking station 170(a), 170(b) and the computer 175.

After coupling a hand-held computer 140, 140(b) to a docking station 170(a), 170(b), respectively, and after coupling the docking station 170(a), 170(b) to a computer 175, an attendee may transfer data from the data storage unit 144 of the hand-held computer 140, 140(b) to the computer 175, via the docking station 170(a), 170(b). The attendee may then use the computer 175 to review any data relating to the sporting event that was obtained by the attendee and stored in the data storage unit 144 of the hand-held computer 140, 140(b) while the attendee was at the sporting event and, specifically, within the local area 500 of the sporting event. The computer 175 may also be used to retrieve data from CD-ROMs, DVD-ROMs, an internet, an intranet, and the like, and transfer or download that data to the data storage unit 144 of the hand-held computer 140, 140(b), via the docking station 170(a), 170(b). The attendee may then review the downloaded data using the hand-held computer 140, 140(b) while at another sporting event, for example.

It is believed that any programming required to implement the described features of the present invention would be readily accomplished by one skilled in the art. Thus, no source or object code is provided herewith.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for enabling attendees to retrieve data regarding a sporting event, on demand, during the sporting event and while at a local area within which the sporting event is being held, comprising:
providing a central computer comprising a central processing unit, a memory unit, and a data input unit;
providing within the local area a data distribution node comprising a transceiver, wherein the data distribution node is coupled to the central computer;
inputting data related to the sporting event into the central computer using the data input unit, wherein the data is stored in the memory unit;
providing to an attendee a hand-held computer comprising a central processing unit, a data storage unit, a data entry unit, a data transfer mechanism, and a display unit, wherein the data transfer mechanism is configured to transfer data between the hand-held computer and the data distribution node;
receiving a request for data related to the sporting event transmitted by the hand-held computer, wherein the request is received by the transceiver of the data distribution node and relayed to the central computer by the data distribution node;
retrieving a requested data related to the sporting event from the memory unit based upon the request for data;
transmitting the requested data to the hand-held computer using the transceiver of the data distribution node; and
displaying the requested data to the attendee using the display unit of the hand-held computer to enable the attendee to retrieve the requested data while within the local area of the sporting event.

2. The method of claim 1, wherein the central computer is installed at a location within the local area.

3. The method of claim 1, wherein the central computer is installed at a location outside the local area.

4. The method of claim 1, wherein the data distribution node comprises a plurality of data distribution nodes installed at a plurality of locations within the local area.

5. The method of claim 1, wherein the data distribution node comprises a portable wireless transceiver array configured for movement between a plurality of locations within the local area.

6. The method of claim 1, wherein the data related to the sporting event input into the central computer comprises real-time commentary related to the sporting event, and the method further comprises:
broadcasting into the local area the real-time commentary related to the sporting event, wherein the broadcasting is performed substantially continually during the sporting event by transmitting the real-time commentary into the local area using the transceiver of the data distribution node;
receiving the real-time commentary using the data transfer mechanism of the hand-held device; and
displaying the real-time commentary to the attendee using the display unit of the hand-held device.

7. The method of claim 1, further comprising providing a docking station to the attendee, the docking station comprising a first connection configured to interface with the hand-held computer and a second connection configured to interface with a computer.

8. A method for enabling attendees at a local area within which a sporting event is being held to participate in an interactive activity during the sporting event using a hand-held computer, comprising:
providing a central computer comprising a central processing unit, a memory unit, and a data input unit;
providing within the local area a data distribution node comprising a transceiver, wherein the data distribution node is coupled to the central computer;
providing to an attendee a hand-held computer comprising a central processing unit, a data storage unit, a data entry unit, a data transfer mechanism, and a display unit, wherein the data transfer mechanism is configured to transfer data between the hand-held computer and the data distribution node;
transmitting an inquiry related to the interactive activity into the local area using the transceiver of the data distribution node;
receiving a response to the inquiry from the attendee, wherein the attendee enters the response into the hand-held computer, the data transfer mechanism of the hand-held computer transmits the response to the data distribution node, the data distribution node receives the response using the transceiver, and the data distribution node transfers the response to the central computer;
processing the response using the central computer in order to generate a result;
transmitting the result to the hand-held computer using the transceiver of the data distribution node; and
displaying the result to the attendee using the display unit of the hand-held computer.

9. The method of claim 8, wherein the interactive activity comprises a poll. the inquiry comprises a question, and the response comprises an answer to the question.

10. The method of claim 9, wherein processing the response comprises:
continuing to receive responses from attendees for a predetermined period of time, wherein the responses comprise a plurality of different answers to the question;
storing the responses in the memory unit of the central computer; and
generating a result at an end of the predetermined period of time by tabulating the plurality of different answers using the central processing unit of the central computer, wherein the result comprises a summary of the number of times each different answer was received from the attendees.

11. The method of claim 8, wherein the interactive activity comprises a game, the inquiry comprises an invitation to participate in the game, and the response comprises an entry for the game.

12. The method of claim 11, wherein processing the response comprises:
continuing to receive responses from attendees for a predetermined period of time;
storing the responses in the memory unit of the central computer; and
generating a result comprising a winning response, at an end of the predetermined period of time, by selecting a response from the responses received from the attendees.

13. The method of claim 12, wherein the result comprises a plurality of winning responses.

14. The method of claim 11, further comprising:
coupling the central computer to a display located within the local area; and
displaying the result to attendees within the local area by using the central computer to present the result on the display.

15. A method for enabling attendees to retrieve data regarding a sporting event and while at a local area within which the sporting event is being held, comprising:
providing a central computer comprising a central processing unit, a memory unit, and a data input unit;
providing within the local area a data distribution node comprising a transmitter, wherein the data distribution node is coupled to the central computer;
providing to an attendee a hand-held computer comprising a central processing unit, a data storage unit, a data entry unit, a data transfer mechanism, and a display unit, wherein the data transfer mechanism is a receiver configured to receive data broadcast by the data distribution node;
inputting data related to the sporting event into the central computer using the data input unit, wherein the data is stored in the memory unit;
broadcasting into the local area the data related to the sporting event, wherein the broadcasting is performed substantially continually during the sporting event by transmitting the data into the local area using the transmitter of the data distribution node;
receiving the data broadcast by the data distribution node using the data transfer mechanism of the hand-held computer;
storing the data broadcast by the data distribution node in the data storage unit of the hand-held computer;
retrieving at least a portion of the data broadcast by the data distribution node from the data storage unit of the hand-held computer, wherein the data retrieved is determined by a request entered into the data entry unit of the hand-held computer; and
displaying the retrieved data to the attendee using the display unit of the hand-held computer to enable the attendee to retrieve the data while within the local area of the sporting event.

16. The method of claim 15, wherein the data related to the sporting event input into the central computer comprises real-time commentary related to the sporting event.

17. The method of claim 15, wherein the central computer is installed at a location within the local area.

18. The method of claim 15, wherein the central computer is installed at a location outside the local area.

19. The method of claim 15, wherein the data distribution node comprises a plurality of data distribution nodes installed at a plurality of locations within the local area.

20. The method of claim 15, wherein the data distribution node comprises a portable wireless transmitter array configured for movement between a plurality of locations within the local area.

21. A system for enabling attendees to retrieve data regarding a sporting event, on demand, while at a local area within which the sporting event is being held, comprising:
a central computer comprising a central processing unit, a memory unit, and a data input unit, wherein the central computer is configured to receive data regarding the sporting event while the sporting event is in progress via the data input unit, and wherein the central computer is configured to transmit data to a hand-held computer while the sporting event is in progress via a data distribution node;
a data distribution node comprising a communication unit, wherein the data distribution node is coupled to the central computer and is located within the local area; and
a plurality of hand-held computers, each hand-held computer comprising a central processing unit, a data storage unit, a data entry unit, a data transfer mechanism, and a display unit, wherein the data transfer mechanism is configured to transfer data between the hand-held computer and the data distribution node while the hand-held computer is located within the local area.

22. The system of claim 21, wherein the data transfer mechanism of the hand-held computer is a receiver and the communication unit of the data distribution node is a transmitter, the data distribution node being configured to substantially continuously broadcast data into the local area for reception by the receiver of the hand-held computer.

23. The system of claim 21, wherein the central computer is located within the local area.

24. The system of claim 21, wherein the data distribution node is wirelessly coupled to the central computer.

25. The system of claim 21, wherein the data distribution node comprises a plurality of data distribution nodes located at a plurality of locations within the local area.

26. The system of claim 21, wherein the central computer is further coupled to a display within the local area.

27. The system of claim 21, wherein the data distribution node is a portable wireless data distribution node configured to be moved between a plurality of locations within the local area while the sporting event is in progress.
